(19) United States
(12) Patent Application Publication
(10) Pub. No.: US 2005/0066035 A1
(43) Pub. Date: Mar. 24, 2005

(54) Method and apparatus for connecting privately addressed networks

(76) Inventors: Aidan Michael Williams, Chifley (AU); John Thomas Judge, Coogee (AU)

Correspondence Address: MOTOROLA, INC., 1303 EAST ALGONQUIN ROAD, IL01/3RD, SCHAUMBURG, IL, 60196, US

(21) Appl. No.: 10/666,407

(22) Filed: Sep. 19, 2003

(51) Int. Cl. G06F 15/16

(52) U.S. Cl. 709/226; 709/245

(57) ABSTRACT

Methods and apparatuses for connecting via a public network at least two privately addressed networks sharing a reserved address space are disclosed herein. One aspect provides a method comprising the steps of automatically assigning respective unique addresses from said reserved address space to each of at least two privately addressed networks and automatically routing communications between the at least two privately addressed networks dependent on the unique addresses via a virtual network link. The method may comprise the further step of automatically creating the virtual network link between the at least two privately addressed networks. The unique addresses may be automatically assigned and the communications may be automatically routed without any human intervention, and no network address translation may be required at the gateways of the privately addressed networks. The virtual network link may comprise a tunnel through the Internet and the unique addresses may comprise unique Internet Protocol (IP) subnet prefixes assigned to each of the at least two privately addressed networks.

### FIELD OF THE INVENTION

The present invention relates to communication networks and more particularly to connecting privately addressed networks.

### BACKGROUND OF THE INVENTION

Users or enterprises requiring a globally unique address space on the Internet are obliged to obtain such addresses from an Internet registry. The Internet Assigned Numbers Authority (IANA) has also reserved the following three blocks of the Internet Protocol (IP) address space for private networks:
10.0.0.0—10.255.255.255 (10/8 prefix)
172.16.0.0—172.31.255.255 (172.16/12 prefix)
192.168.0.0—192.168.255.255 (192.168/16 prefix)

The first block comprises a single class A network number, the second block comprises a set of 16 contiguous class B network numbers, and the third block comprises a set of 256 contiguous class C network numbers. The foregoing three reserved blocks of IP address space may be used without coordination by IANA or any other Internet registry and may thus result in globally ambiguous addressing. IP routing cannot provide correct operations in the presence of ambiguous addressing.

Official specification documents of the Internet Engineering Taskforce (IETF) are Request For Comments documents (RFC's), that are first published as Internet Drafts. RFC1918, entitled “Address Allocation for Private Internets”, requires that “routing information about private networks shall not be propagated on inter-enterprise links, and packets with private source or destination addresses should not be forwarded across such links”. RFC1918 goes on to state: “While not having external (outside of enterprise) IP connectivity private hosts can still have access to external services via mediating gateways (e.g., application layer gateways)” and “it is possible for two sites, who both coordinate their private address space, to communicate with each other over a public network. To do so they must use some method of encapsulation at their borders to a public network, thus keeping their private addresses private”.

Existing implementations of private networks employ Network Address Translation (NAT), which allows a device such as a router to act as an agent between a public network (e.g., the Internet) and a private network. This means that a single unique IP address is required to represent a group of devices or computers connected to a private network. Network Address Translation is typically performed at a gateway between a private network and a public network and may be implemented in a device such as a firewall, router or computer.

FIG. 1 shows a networking environment including privately addressed or home networks 110 and 120 both connected to the Internet 130 via residential gateways 115 and 125, respectively. Each of the residential gateways 115 and 125 include a network address translation (NAT) capability. Both the privately addressed networks 110 and 120 share the identical private address range, being 192.168.1.x. Hosts or devices connected to the privately addressed networks 110 and 120 can be uniquely identified by means of a value allocated to the x argument in the foregoing address range. However, such a value is only unique within the particular privately addressed network the value is allocated for, and ambiguity can thus result if the same value is allocated to devices in both privately addressed networks.

In the arrangement shown in FIG. 1, hosts or devices connected to the privately addressed networks 110 and 120 can access external hosts or devices such as those connected to the public Internet 130. However, hosts or devices connected to one of the privately addressed networks 110 and 120 cannot access hosts or devices connected to the other of the privately addressed networks 110 and 120 without manual configuration or the use of a signalling protocol. In other words, communications directed from devices or applications external to a privately addressed network to devices or hosts internal to the privately addressed network require manual configuration or a signalling protocol to resolve potential ambiguities with regard to private addressing.

Disadvantageously, manual configuration requires skill and effort that is beyond many users of privately addressed networks, particularly home networks. Furthermore, most existing Internet applications require modification to implement the signalling required to pass through network address translation (NAT) at the gateway of a privately addressed network.

### SUMMARY OF THE INVENTION

Methods and apparatuses are disclosed herein for connecting, via a public network, at least two privately addressed networks sharing a reserved address space.

One aspect provides a method comprising the steps of automatically assigning respective unique addresses from the reserved address space to each of at least two privately addressed networks and automatically routing communications between the at least two privately addressed networks dependent on the unique addresses via a virtual network link. The method may comprise the further step of automatically creating the virtual network link between the at least two privately addressed networks.

The unique addresses may be automatically assigned and the communications may be automatically routed without human intervention, and no network address translation may be required at a gateway of a privately addressed destination network. The virtual network link may comprise a tunnel through the Internet and the unique addresses may comprise Internet Protocol (IP) subnet prefixes.

In one embodiment, the addresses of the at least two privately addressed networks are automatically compared and a virtual network link is automatically created between the at least two privately addressed networks only if no address conflict is detected. The addresses also comprise the addresses of any other privately addressed networks connected to the at least two privately addressed networks by existing virtual network links. If an address conflict is detected, a different address is automatically assigned to one of the privately addressed networks and the addresses of the two privately addressed networks are again automatically compared. This process can recur until no address conflict exists, whereupon a virtual network link is automatically created between the two privately addressed networks.

Another aspect provides a method for automatically routing communications between privately addressed networks via a virtual network link. The method comprises the steps of automatically creating at least one virtual network link between the privately addressed networks for routing communications, automatically assigning respective unique addresses from a reserved address space common to the privately addressed networks to devices connected to the privately addressed networks and automatically routing communications between the privately addressed networks dependent on the unique addresses via the at least one virtual network link. In one embodiment, the privately addressed networks collaborate automatically to detect addresses already assigned.

The apparatuses disclosed perform the methods described hereinbefore.

### BRIEF DESCRIPTION OF THE DRAWINGS

A small number of embodiments of the present invention are described hereinafter, by way of example only, with reference to the accompanying drawings in which:

FIG. 1 is a diagram of a networking environment;

FIG. 2 is a diagram of a networking environment for describing an embodiment of the present invention;

FIG. 3 is a flow diagram of a method for connecting privately addressed networks via a public network;

FIG. 4 is a flow diagram of another method for connecting privately addressed networks via a public network;

FIG. 5 is a flow diagram of an augmented tunnel setup protocol;

FIG. 6 is a diagram of a networking environment including a tunnel;

FIG. 7 is a block diagram of a privately addressed residential or home network with which embodiments of the present invention can be practiced; and

FIG. 8 is a block diagram illustrating the architecture of a gateway with which embodiments of the present invention can be practiced.

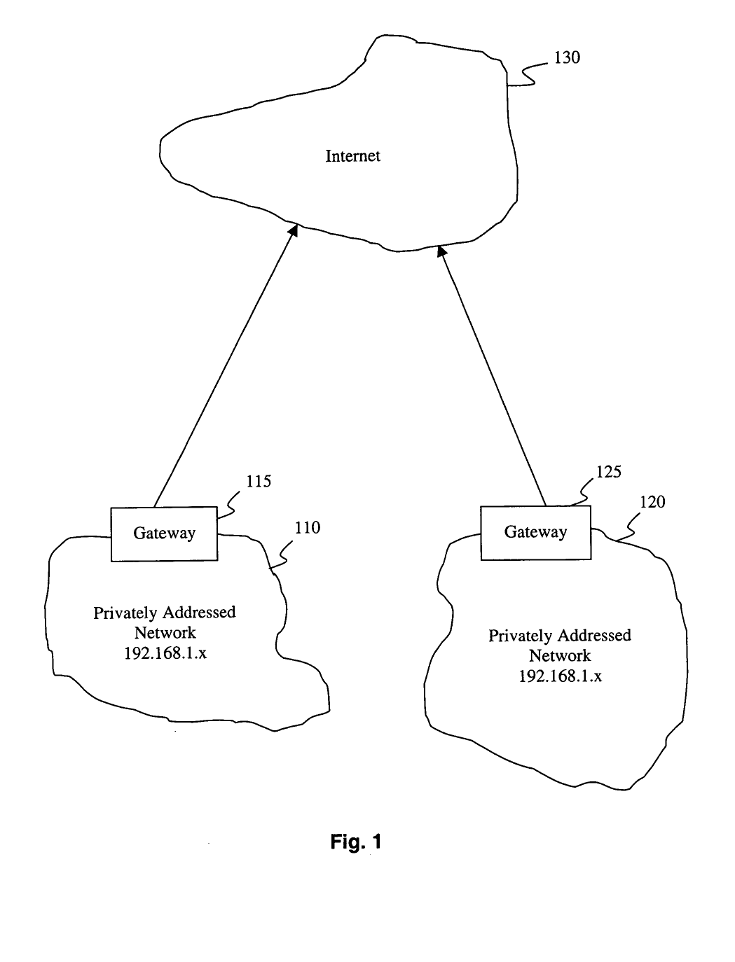

### DETAILED DESCRIPTION OF THE PREFERRED EMBODIMENT OF THE INVENTION

Embodiments of methods and apparatuses are described hereinafter for connecting privately addressed networks via a public network. The embodiments are described with reference to the Internet as a public network, using Transmission Control Protocol and Internet Protocol (TCP/IP). Notwithstanding, other embodiments of the present invention are not intended to be limited in this manner, since the principles described hereinafter have general applicability to other types of communication networks and network protocols. Certain of the embodiments described have applicability to Internet Protocol version 4 (IPv4), which is limited to a 32-bit address space. However, the embodiments may also have applicability to Internet Protocol version 6 (IPv6), which has a 128-bit address space. For example, even when a substantially wider address space is available, globally unique addresses may not be desirable for security reasons under certain circumstances.

Embodiments described hereinafter also relate to privately addressed networks, such as enterprise private networks and home or residential private networks. Such networks include, but are not limited to, local area networks (LAN's), wireless networks, power-line networks and phone-line networks.

Embodiments described hereinafter use tunnels as virtual network links to connect privately addressed networks. Tunnelling is a technology that enables a first network to transfer data via a second network's connections by encapsulating the first network's protocol within packets carried by the second network. Various tools, such as Point-to-Point Tunnelling Protocol (PPTP) by Microsoft, Generic Routing Encapsulation (GRE) as defined in RFC1702, tunnel mode Internet Security Protocol (IPSec) and IP-in-IP Encapsulation Protocol as defined in RFC1853 are available for automatic tunnel establishment. For example, PPTP enables use of the Internet to transmit data across a virtual private network (VPN) by embedding PPTP's own network protocol within the TCP/IP packets carried by the Internet.

The terms “connect”, “connecting”, “connection”, and other derivatives thereof, as used in the present disclosure, are not intended to limit the connections between networks, gateways, etc., to direct or electrical connections. The connections may be indirect in that these may be via one or more intermediate stages such as other networks, gateways, etc. The purpose of the connections is to provide a link or coupling for communication.

Networking Environment

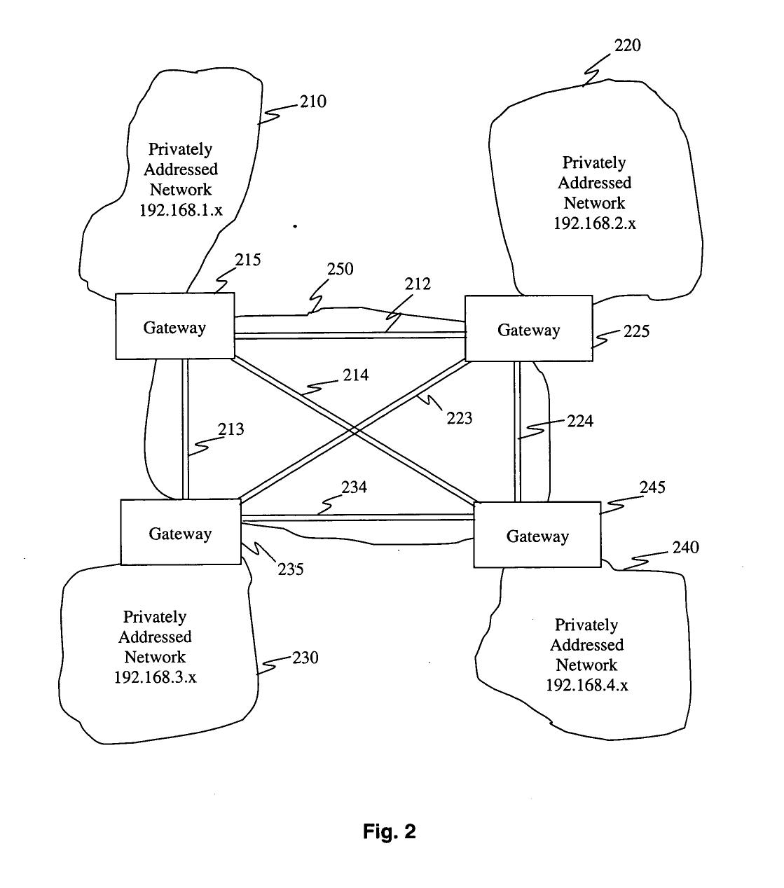

FIG. 2 is a diagram of a networking environment for describing embodiments of the present invention. Privately addressed networks 210, 220, 230 and 240 are connected to the Internet 250 via gateways 215, 225, 235 and 245, respectively. Hosts and devices connected directly to the Internet 250 (i.e., not via a privately addressed network) are globally and uniquely addressable, whereas hosts and devices connected to the privately addressed networks 210, 220, 230 and 240 are privately addressable from within the respective privately addressed network.

Privately addressed networks 220, 230 and 240 are connected to privately addressed network 210 via virtual network links 212, 213 and 214, respectively. Similarly, privately addressed networks 230 and 240 are connected to privately addressed network 220 via virtual network links 223 and 224, respectively. Further, privately addressed network 240 is connected to privately addressed network 230 via virtual network link 234. Each of privately addressed networks 210, 220, 230 and 240 has gateways 215, 225, 235 and 245, respectively, to which the virtual network links are connected.

A fully meshed topology can be employed whereby every privately addressed network in a group has a virtual network link directly connected to every other privately addressed network in the group of privately addressed networks. FIG. 2 shows a fully meshed topology in relation to the group of privately addressed networks 210, 220, 230 and 240. Alternatively, however, virtual network links need only be created between privately addressed networks specifically requiring communication with each other.

A gateway is an apparatus that is located at the boundary between networks to facilitate communications between devices connected to those networks. In the network environment shown in FIG. 2, the gateways 215, 225, 235 and 245 are located between each of privately addressed networks 210, 220, 230 and 240 and the Internet 250.

Methods for Connecting Privately Addressed Networks Via a Public Network

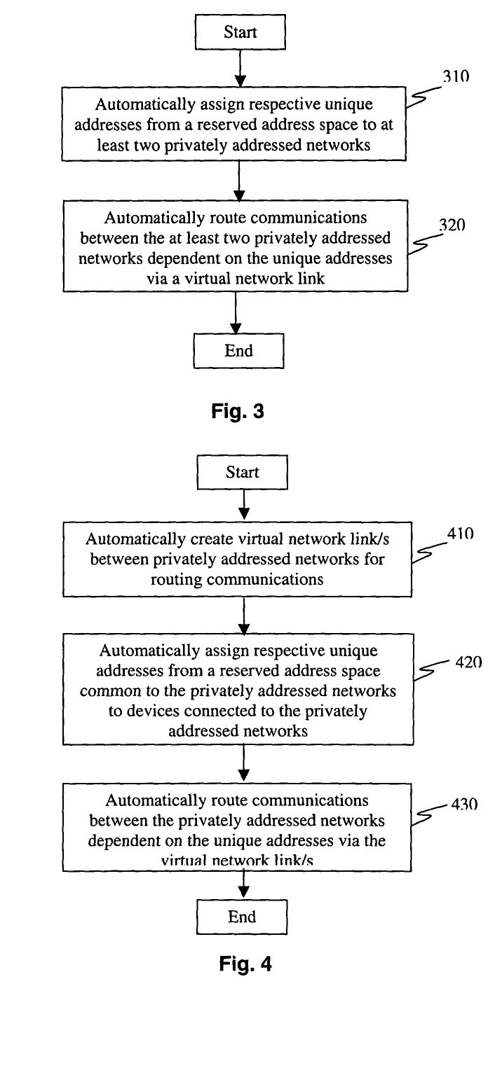

FIG. 3 is a flow diagram of a method for connecting via a public network at least two privately addressed networks sharing a reserved address space. At step 310, unique addresses from the reserved address space are automatically assigned to each of the at least two privately addressed networks. This enables non-conflicting addresses to be automatically assigned to devices or hosts connected to each of the privately addressed networks. At step 320, communications between the at least two privately addressed networks are automatically routed dependent on the unique addresses via a virtual network link.

In an embodiment according to the method of FIG. 3, each privately addressed network is allocated a unique IP subnet to prevent address conflicts between the privately addressed networks. FIG. 2 shows the privately addressed networks 210, 220, 230 and 240, each having different subnet addresses 192.168.1.x, 192.168.2.x, 192.168.3.x, and 192.168.4.x, respectively.

A method for automatically routing communications between privately addressed networks via a virtual network link, said method comprising the steps of:
automatically creating at least one virtual network link between said privately addressed networks for routing communications;
automatically assigning respective unique addresses from a reserved address space common to said privately addressed networks to devices connected to said privately addressed networks; and
automatically routing communications between said privately addressed networks dependent on said unique addresses via said at least one virtual network link.

FIG. 4 is a flow diagram of a method for automatically routing communications between privately addressed networks via a virtual network link. At step 410, at least one virtual network link is automatically created for routing of communications between the privately addressed networks. At step 420, unique addresses from a reserved address space are automatically assigned to devices connected to the privately addressed networks. Communications are automatically routed between the privately addressed networks dependent on the unique addresses via the at least one virtual network link, at step 430.

In an embodiment according to the method of FIG. 4, each privately addressed network uses the same subnet address (e.g., 192.168.1/24). Devices or hosts connected to the privately addressed networks are assigned unique client addresses (e.g., 192.168.1.1, 192.168.1.2, etc.) after the one or more virtual network links are created. Multiple virtual network links can be created in parallel. This embodiment uses the concept of IP bridging, which enables each privately addressed network to see the other privately addressed networks connected in a group by virtual network links as a large subnet. IP bridging is described in the Internet Draft document “draft-ietf-ipv6-multilink-subnets-00.txt”, which is incorporated herein by reference and is readily obtainable by persons skilled in the art from a variety of websites and archives accessible via the Internet (e.g., http://www.ietf.org/internet-drafts/and http://www.watersprings.org/pub/id/).

Assignment of Unique Addresses from the Reserved Address Space

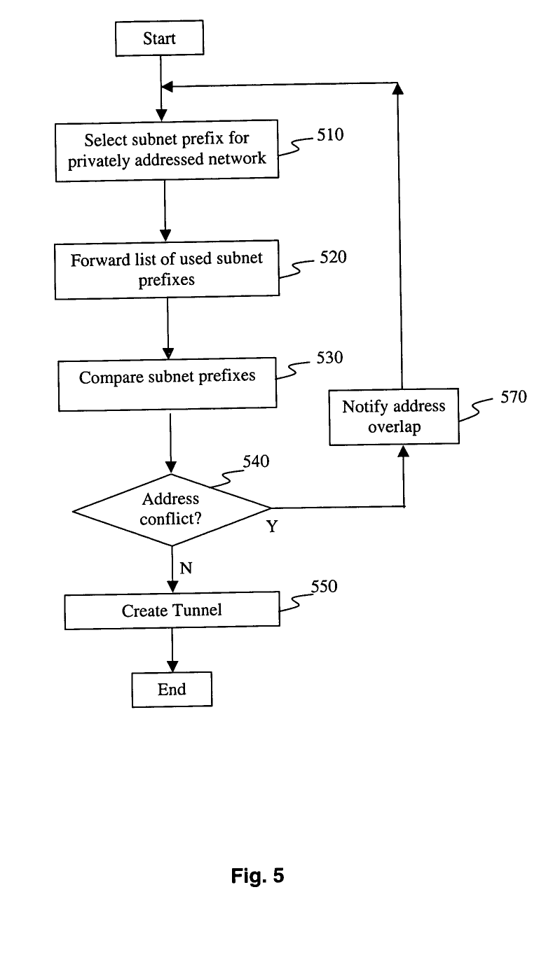

Automatic assignment of unique addresses can be performed in a number of ways, a small number of which are described hereinafter:
An augmented tunnel setup protocol that avoids addresses or subnets already in use. Such an augmented tunnel setup protocol is described hereinafter with reference to FIG. 5.
Dynamic Host Configuration Protocol (DHCP) servers located at the gateways of the privately addressed networks collaborating with one another to avoid assigning conflicting addresses (e.g., DHCPv6 servers running over site-local multicast).
DHCP servers ‘pinging’ or otherwise probing all connected privately addressed networks to determine whether a particular IP number is already in use before assigning that IP number to a local device or host.
Zero-configuration protocols providing automatic configuration of subnets (i.e., in the absence of human administrators).
Zero configuration protocols such as Unique Identifier Allocation Protocol (UIAP) and version 3 of Open Shortest Path First (zOSPF) can be run over the virtual and physical links that make up the connected privately addressed networks to automatically assign addresses and perform IP routing. UIAP is described in the Internet Draft document “draft-white-zeroconf-uiap-01.txt”. A method for performing subnet allocation using UIAP is described in the Internet Draft document “draft-white-zeroconf-subnet-alloc-01.txt”. zOSPF is described in the Internet Draft document “draft-dimitri-zOSPF-00.txt”. The foregoing Internet Draft documents are readily obtainable by persons skilled in the art from a variety of websites and archives accessible via the Internet (e.g., http://www.ietf.org/internet-drafts/) and are incorporated herein by reference.
   UIAP Over Tunnels For NAT-less Connection of Privately Addressed Networks

The Unique Identifier Allocation Protocol (UIAP) can be used to automatically configure IP addressing in a network of connected links.

In a first step, tunnels are established between two or more gateways. Tunnel establishment may occur in parallel. The tunnels between gateways connect each privately addressed network behind a gateway into a larger connected network. This network forms a domain in which addressing conflicts in the privately addressed networks must not occur and is termed the ‘allocation extent’. Additional tunnels further increase the allocation extent.

In a second step, the UIAP subnet allocation protocol is executed throughout the allocation extent. The UIAP subnet allocation protocol is used to claim a unique subnet address or range of addresses for each link in the allocation extent. Once a subnet number has been validated as unique by the UIAP, the subnet number may be used to configure IP addressing for devices or hosts attached to that link.

A standard routing protocol such as OSPF or Routing Information Protocol (RIP) can be used to exchange IP reachability information throughout the allocation extent.

An alternative to the second step is to run a routing protocol incorporating address allocation functionality throughout the allocation extent. An example of such a routing protocol is zOSPF.

An Augmented Tunnel Setup Protocol

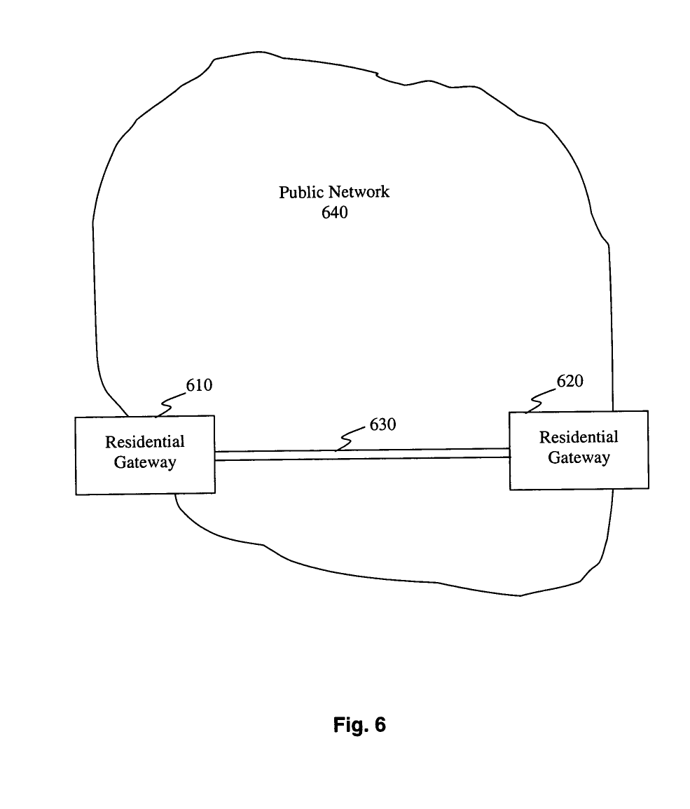

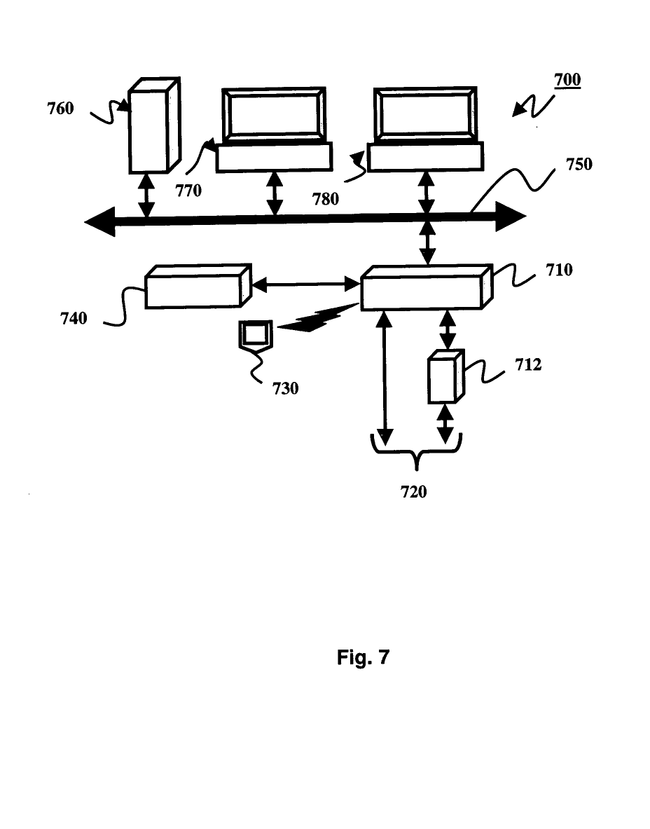

FIG. 5 is a flow diagram of an augmented tunnel setup protocol with reference to the networking environment shown in FIG. 6. The tunnel setup protocol is augmented to avoid address conflicts.

Referring to FIG. 6, assume that a tunnel 630 is to be created via a public network 640 between a residential gateway 610 and a residential gateway 620 and that the tunnel creation procedure is initiated by the residential gateway 620.

Returning now to FIG. 5, a subnet prefix n is selected from the range [0:255] for allocation or assignment to the residential gateway 620 at step 510. Such selection can occur randomly, successively, or according to an allocation algorithm. Then, at step 520, the residential gateway 620 forwards a list of all the subnet prefixes used by the residential gateway 620. This initiates setup of the tunnel. The list includes the subnet prefix assigned to the residential gateway 620 as well as the subnet prefixes of any other gateways connected to the residential gateway 620 by a tunnel. At step 530, the residential gateway 610 compares the list of subnet prefixes against the residential gateway 610's own subnet prefix and the subnet prefixes of any other gateways connected to the residential gateway 610 by a tunnel. The foregoing comparison involves receiving the list of subnet prefixes and checking for any address conflicts between the subnet prefixes in the list and the subnet prefix of the residential gateway 610 and the subnet prefixes of any other gateways connected to the residential gateway 610 by a tunnel. If there are no subnet prefix overlaps (N) at decision step 540, a tunnel is created between the residential gateways 610 and 620 at step 550 and the procedure terminates at step 560. Alternatively, if an address prefix conflict is detected (Y) at decision step 540, the residential gateway 620 is notified of the conflict by the residential gateway 610 at step 570. Processing then reverts to step 510, whereupon another value of subnet prefix is selected for assignment to the residential gateway 620. The foregoing selection and allocation process can be repeated until an address conflict is avoided.

In the event that the subnet prefix of a residential gateway connected to residential gateway 610 is identical to a subnet prefix of a residential gateway connected to residential gateway 620, assignment of a different subnet prefix for one of the remote residential gateways is necessary. This situation may require the intervention of a third party or removal of the conflicting remote gateway. The remotely reachable prefixes (i.e., those not directly attached to the gateways 610 and 620) are individually tagged so that the tunnel creation process can be aborted when such a conflict occurs. In an embodiment based on zOSPF (a zero-configuration version of the Open Shortest Path First protocol), each of the participating gateways are involved at the tunnel creation stage and are thus able to resolve such conflicts.

Either gateway can perform or control establishment of the tunnel. Practically, tunnel establishment is likely initiated by a user of a web-browser or computer connected to a private network. The user may need to be involved, since an address conflict requiring re-selection of a subnet prefix may result in network disruption. However, such a disruption should be limited to the tunnel initiator's network.

While the augmented tunnel setup protocol is described hereinbefore in terms of subnet prefixes, it will be understood by persons skilled in the art that other embodiments that employ addresses as opposed to subnet prefixes are also possible.

Forwarding and Routing

Standard or commonly used IP routing and forwarding techniques are employed to ensure that data packets travel via the correct tunnel to reach the appropriate privately addressed network. IP routing tables, which are typically constructed automatically using the address prefixes assigned to each network or learned via the tunnel setup protocol, are well understood by persons skilled in the art. An example of an IP routing table is shown hereinafter in Table 1.

TABLE 1

| DESTINATION | | | | | | |
|---|---|---|---|---|---|---|
| INTERFACE | GATEWAY | FLAGS | REFS | USE | MTU | |
| default | 210.49.27.1 | UGS | 11 | 33903 | — | ex0 |
| 172.16.170/24 | 127.0.0.1 | UGS | 0 | 0 | — | gif1 |
| 172.16.228/24 | link#4 | UC | 2 | 0 | — | tlp3 |
| 210.49.27 | link#5 | UC | 1 | 0 | — | ex0 |

The left-most column of Table 1 shows the destination address prefix/length for routing, and the right-most column shows the interface that is to be used. A default table entry is used if no other match exists. Interface gif1 is a tunnel. Interface tlp3 is a network card attached to a private network. Interface ex0 is a network interface attached to the public internet. Thus, any packets destined for address 172.16.170.x are forwarded over the tunnel gif1 to a remote private network. Any packets destined for the address 172.16.228.x are forwarded via the tlp3 interface to the local private network. IP routing tables can be dynamically updated by a routing protocol.

In a fully meshed topology, every privately addressed network has a tunnel to every other privately addressed network. Thus, every gateway has a tunnel directly connected to the gateway of a potential destination. Another approach that relaxes the requirement for a fully meshed topology is to run a routing protocol over the connected mesh of virtual and physical links, thus enabling a privately addressed network to comprise multiple routed links. Yet another approach is to augment the tunnel setup protocol to exchange some routing information. Such routing information may be restricted to privately addressed networks directly connected by a tunnel. Also, such a scheme may not automatically adapt to changes (e.g., privately addressed network A will not be aware of a tunnel created from privately addressed network B to privately addressed network C unless the tunnel between privately addressed networks A and B is re-established. Re-establishment of tunnels may be necessary under various circumstances, such as when power is restored to gateways that are being power-cycled or when global addresses assigned to gateways are changed.

Privately Addressed Network Environment

FIG. 7 is a block diagram of a privately addressed residential or home network 700. The network 700 has a server 760 and two other computers 770 and 780 connected by an Ethernet network 750 to a residential gateway 710. The residential gateway 710 is also connected to a print server 740 and may be connected wirelessly to a PDA 730, for example. The gateway 710 may be connected by an appropriate communications interface directly, or by a modem 712 indirectly, to another remote home network or a public network such as the Internet, as indicated by connections 720. The foregoing is merely an example of the configuration of a home network and is not meant to be limiting to the embodiments of the invention.

Gateway Hardware Architecture

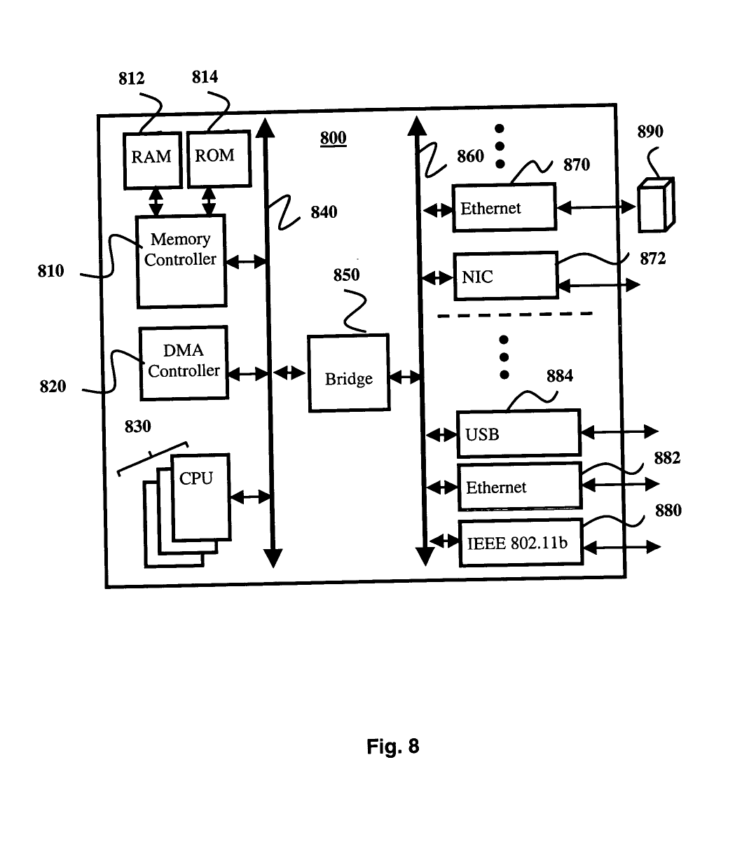

FIG. 8 is a block diagram illustrating the architecture of a gateway 800 with which the embodiments of the invention may be practiced. Specifically, the gateway 800 may be used to implement the gateways 210, 220, 230 and 240 of FIG. 2, the residential gateways 610 and 620 of FIG. 6 and the residential gateway 710 of FIG. 7. The gateway 800 may comprise a residential gateway for use in home networks. The gateway 800 comprises one or more central processing units (CPUs) 830, a memory controller 810, and storage units 812, 814. The memory controller 810 is coupled to the storage units 812, 814, which may be random access memory (RAM), read-only memory (ROM), and any of a number of storage technologies well know to those skilled in the art. The CPU 830 and the memory controller 810 are coupled together by a processor bus 840. A direct-memory-access (DMA) controller 820 may also be coupled to the bus 840. The DMA controller 820 enables the transfer of data to and from memory directly, without interruption of the CPU 820. As shown in FIG. 8, the processor bus 840 serves as the memory bus, but it will be well understood by those skilled in the art that separate processor and memory buses may be practiced. Software to implement functionality of the gateway may be embedded in the storage unit, including an operating system, drivers, firmware, and applications. The CPU 830 functions as the processing unit of the gateway, however, other devices and components may be used to implement the processing unit.

A bridge 850 interfaces the processor bus 840 and a peripheral bus 860, which typically operates at lower data rates than the processor bus 840. Various external interfaces are in turn coupled to the peripheral bus 860. The gateway 800 has as examples of such interfaces an IEEE 802.11b wireless interface 880, an Ethernet interface 882, and a Universal Serial Bus (USB) interface 884. The foregoing are merely examples and other network interfaces may be practiced, such as a Token Ring interface, other wireless LAN interfaces, and an IEEE 1394 (Firewire) interface. For connections external to a privately addressed network other network interfaces may be practiced. For example, the gateway 800 may have a network interface card 872 for connection to another network. Alternatively, the gateway 800 may comprise an Ethernet interface 870, which can be connected to a suitable modem 890 (e.g., a broadband modem). Still other network interfaces may be practiced including ATM and DSL, as examples of a few.

The methods for connecting privately addressed networks may be implemented as software or computer programs carried out in conjunction with the processing unit and the storage unit(s) of the gateway. In certain embodiments, addresses are assigned by a DHCP server integrated into the gateway 800. However, it would be readily appreciated by those skilled in the art that the DHCP server can be located externally to the gateway 800.

While the gateway 800 has been depicted as a standalone device by itself, or in combination with a suitable modem, it will be well understood by those skilled in the art that the gateway may be implemented using a standard computer system with suitable software to implement the gateway functionality. Other variations may also exist. Specifically, the gateway 800 may be implemented as a discrete consumer device, which is configurable by a web interface attached to a privately addressed network. Hardware platforms such as those capable of performing the functions of a firewall or router can also be used to implement the methods described herein.

Advantageously, the embodiments described hereinbefore enable devices or hosts connected to separate privately addressed networks to communicate without the need for network address translation (NAT) at the gateways of the privately addressed networks.

The foregoing detailed description provides exemplary embodiments only, and is not intended to limit the scope, applicability or configurations of the invention. Rather, the description of the exemplary embodiments provides those skilled in the art with enabling descriptions for implementing an embodiment of the invention. It should be understood that various changes may be made in the function and arrangement of elements without departing from the spirit and scope of the invention as set forth in the appended claims.

1. A method for connecting via a public network at least two privately addressed networks sharing a reserved address space, said method comprising the steps of:
automatically assigning respective unique addresses from said reserved address space to each of said at least two privately addressed networks; and
automatically routing communications between said at least two privately addressed networks dependent on said unique addresses via a virtual network link.

2. The method of claim 1, wherein said communications are automatically routed without network address translation at a gateway of either of said at least two privately addressed networks.

3. The method of claim 1, wherein said unique addresses are automatically assigned and said communications are automatically routed without human intervention.

4. The method of claim 1, wherein said public network comprises the Internet and said unique addresses comprise unique Internet Protocol (IP) subnet prefixes assigned to each of said at least two privately addressed networks.

5. The method of claim 1, comprising the further step of automatically creating said virtual network link between said at least two privately addressed networks.

6. The method of claim 5, wherein said unique addresses are assigned prior to creating said virtual network link.

7. The method of claim 5, wherein said virtual network link comprises a tunnel through the Internet.

8. The method of claim 5, wherein said automatically creating step comprises the sub-steps of:
automatically comparing the addresses of said at least two privately addressed networks, said addresses further comprising addresses of any other privately addressed networks connected by existing virtual network links to said at least two privately addressed networks; and
automatically creating said virtual network link between said at least two privately addressed networks if no address conflict is detected in said comparing step.

9. The method of claim 8, further comprising the steps of:
automatically assigning a different address to one of said at least two privately addressed networks if an address conflict is detected in said comparing step; and
automatically creating said virtual network link between said at least two privately addressed networks if no address conflict is detected between said different address and the addresses of the other of said at least two privately addressed networks, and no address conflict is detected between said different address and the addresses of any other privately addressed networks connected by existing virtual network links to the other of said at least two privately addressed networks.

10. A method for automatically routing communications between privately addressed networks via a virtual network link, said method comprising the steps of:
automatically creating at least one virtual network link between said privately addressed networks for routing communications;
automatically assigning respective unique addresses from a reserved address space common to said privately addressed networks to devices connected to said privately addressed networks; and
automatically routing communications between said privately addressed networks dependent on said unique addresses via said at least one virtual network link.

11. The method of claim 9, comprising the further step of automatically collaborating between said privately addressed networks to detect addresses already assigned.

12. An apparatus for connecting via a public network at least two privately addressed networks sharing a reserved address space, said apparatus comprising:
at least one communications interface for transmitting and receiving data;
a storage unit for storing data and instructions to be performed by a processing unit; and
a processing unit coupled to said at least one communications interface and said storage unit, said processing unit programmed to:
automatically assign respective unique addresses from said reserved address space to each of said at least two privately addressed networks; and
automatically route communications between said at least two privately addressed networks dependent on said unique addresses via a virtual network link.

13. The apparatus of claim 12, wherein said public network comprises the Internet and said processing unit is programmed to automatically assign unique Internet Protocol (IP) subnet prefixes to each of said privately addressed networks.

14. The apparatus of claim 11, wherein said processing unit is programmed to automatically route said communications without network address translation at a gateway of either of said two privately addressed networks.

15. The apparatus of claim 12, wherein said processing unit is further programmed to automatically create said virtual network link between said at least two privately addressed networks.

16. The apparatus of claim 15, wherein said virtual network link comprises a tunnel through the Internet.

17. The apparatus of claim 15, wherein said processing unit is programmed to:
automatically compare the addresses of said at least two privately addressed networks, each of said addresses further comprising addresses of any other privately addressed networks connected by existing virtual network links to said at least two privately addressed networks; and
automatically create said virtual network link between said at least two privately addressed networks if no address conflict was detected when said addresses were compared.

18. The apparatus of claim 17, wherein said processing unit is programmed to:
automatically assign a different address to one of said at least two privately addressed networks if an address conflict was detected when said addresses were compared; and
automatically create said virtual network link between said at least two privately addressed networks if no address conflict is detected between said different address and the addresses of the other of said at least two privately addressed networks, and no address conflict is detected between said different address and the addresses of any other privately addressed networks connected by existing virtual network links to the other of said at least two privately addressed networks.

19. The apparatus of claim 12, wherein said apparatus comprises a network gateway device.

20. The apparatus of claim 19, further comprising a Dynamic Host Configuration Protocol (DHCP) server.
